(19) United States
(12) Patent Application Publication
(10) Pub. No.: US 2008/0236851 A1
(43) Pub. Date: Oct. 2, 2008

(54) Furrower

(76) Inventor: John Winkle, Villa Hills, KY (US)

Correspondence Address: TAFT, STETTINIUS & HOLLISTER LLP, SUITE 1800, 425 WALNUT STREET, CINCINNATI, OH, 45202-3957, US

(21) Appl. No.: 11/729,642

(22) Filed: Mar. 29, 2007

(51) Int. Cl. A01B 21/04

(52) U.S. Cl. 172/548

(57) ABSTRACT

A furrowing attachment comprising at least three cutters axially spaced apart from one another and operatively coupled to one another, the three cutters comprising a second cutting disc interposing a first cutting disc and a cutting blade, the first cutting disc, the second cutting disc, and the cutting blade are coaxial, where each of the cutting discs includes a plurality of circumferentially distributed teeth, at least one of the circumferentially distributed teeth has an angle of attack between five and sixty degrees, and where the second cutting disc has a smaller diameter than the first cutting disc and a greater diameter than the cutting blade, and wherein one rotation of the first cutting disc corresponds with one rotation of the second cutting disc and one rotation of the cutting blade.

### FIELD OF THE INVENTION

The present invention is directed to methods and devices for forming furrows and, more specifically, to handheld furrowing equipment and replacement furrowing attachments for forming furrows.

### INTRODUCTION TO THE INVENTION

The present invention includes furrowers and replacement furrowing attachments configured to create a beveled furrow. In exemplary form, the invention also includes methods of creating beveled furrows such as those that may delineate a lawn from an adjacent mulched area.

It is a first aspect of the present invention to provide a furrowing attachment comprising at least three cutters axially spaced apart from one another and operatively coupled to one another, the three cutters comprising a second cutting disc interposing a first cutting disc and a cutting blade, the first cutting disc, the second cutting disc, and the cutting blade are coaxial, where each of the cutting discs includes a plurality of circumferentially distributed teeth, at least one of the circumferentially distributed teeth has an angle of attack between five and sixty degrees, and where the second cutting disc has a smaller diameter than the first cutting disc and a greater diameter than the cutting blade, and wherein one rotation of the first cutting disc corresponds with one rotation of the second cutting disc and one rotation of the cutting blade.

In a more detailed embodiment of the first aspect, the diameter of the first cutting disc is between four to twenty inches, the diameter of the second cutting disc is between three to nineteen inches, and the diameter of the cutting blade is between two to eighteen inches. In yet another more detailed embodiment, the first cutting disc includes at least three circumferentially distributed teeth, the second cutting disc includes at least three circumferentially distributed teeth, and the cutting blade includes at least two blades. In a further detailed embodiment, the at least one inwardly angled tooth of the first cutting disc includes a cutting edge normal the angle of attack, and the at least one inwardly angled tooth of the second cutting disc includes a cutting edge normal to the angle of attack. In still a further detailed embodiment, the embodiment further comprises a plurality of spacers interposing the at least three cutters, where each of the spacers includes a orifice therethrough, and a threaded fastener, where each of the at least three cutters includes an opening through a center thereof, and where the threaded fastener passes through each orifice of the spacers and each opening of the at least three cutters to maintain the orientation of the spacers and the at least three cutters with respect to one another.

In yet another more detailed embodiment of the first aspect, at least one of the circumferentially distributed teeth of at least one of the first disc, the second disc, and the third disc is radially aligned and in parallel with a hub of its corresponding disc. In still another more detailed embodiment, at least one of the circumferentially distributed teeth of each of the first disc, the second disc, and the third disc is radially aligned and in parallel with the hub of its corresponding disc. In a further detailed embodiment, the second cutting disc includes at least three circumferentially distributed teeth, the three circumferentially distributed teeth are each angled between five and sixty degrees, and the angles of each of the three circumferentially distributed teeth differ from one another. In still a further detailed embodiment, the three circumferentially distributed teeth are in series with one another, and the angles of each of the three circumferentially distributed teeth incrementally increase with respect to one another.

It is a second aspect of the present invention to provide a furrowing attachment comprising: (a) a first wheel including a rotational axis and at least two cutting projections radially spaced from the rotational axis and angled with respect to the rotational axis between twenty and eighty-five degrees, the first wheel also including at least one cutting edge substantially perpendicular to the rotational axis; and (b) a second wheel operatively coupled to the first wheel and axially spaced apart from the first wheel, the second wheel including a rotational axis coaxial with the rotational axis of the first wheel, the second wheel including at least two cutting projections radially spaced from the rotational axis and angled with respect to the rotational axis between twenty and eighty-five degrees, the second wheel also including at least one cutting edge substantially perpendicular to the rotational axis, where a radius of the first wheel is less than a radius of the second wheel, and where one rotation of the first wheel corresponds with one rotation of the second wheel.

In a more detailed embodiment of the second aspect, the second wheel includes at least five cutting projections radially spaced from the rotational axis and angled with respect to the rotational axis between twenty and eighty-five degrees, and the at least five cutting projections are arranged in an undulating pattern. In yet another more detailed embodiment, the first wheel includes at least four cutting edges substantially perpendicular to the rotational axis, and the first wheel includes only two cutting projections radially spaced from the rotational axis and angled with respect to the rotational axis between twenty and eighty-five degrees. In a further detailed embodiment, the embodiment further comprises at least two blades axially spaced apart from the first wheel and the second wheel, where the at least two blades are further axially spaced apart from the first wheel than the second wheel, and where each blade includes a radial dimension less than a radius of the second wheel. In still another detailed embodiment, the embodiment further comprises a series of angled blades axially spaced apart from the first wheel and the second wheel, where at least one of the series of blades includes a radial dimension less than a radius of the second wheel.

It is a third aspect of the present invention to provide a handheld furrower comprising: (a) a handheld, portable piece of equipment having an internal combustion engine coupled to a drive shaft that is coupled to a rotational end, the internal combustion engine having a throttle control operative to at least one of increase and decrease rotation of the rotational end; and (b) a furrowing attachment coupled to the rotational end of the handheld, portable piece of equipment, the furrowing attachment comprising at least three cutters axially spaced apart from one another and operatively coupled to one another, the three cutters comprising a second cutting disc interposing a first cutting disc and a cutting blade, the first cutting disc, the second cutting disc, and the cutting blade are coaxial, where each of the cutting discs includes a plurality of circumferentially distributed teeth, at least one of the circumferentially distributed teeth has an angle of attack between five and sixty degrees, and where the second cutting disc has a smaller diameter than the first cutting disc and a greater diameter than the cutting blade, and wherein one rotation of the first cutting disc corresponds with one rotation of the second cutting disc and one rotation of the cutting blade.

### BRIEF DESCRIPTION OF THE DRAWINGS

FIG. 1 is an elevated perspective view of an exemplary furrow attachment in accordance with the instant invention;

FIG. 2 is an overhead view of a first blade for use with the exemplary furrow attachment of FIG. 1;

FIG. 3 is an overhead view of a second blade for use with the exemplary furrow attachment of FIG. 1;

FIG. 4 is an overhead view of a third blade for use with the exemplary furrow attachment of FIG. 1;

FIG. 5 is an overhead view of the exemplary furrow attachment of FIG. 1;

FIG. 6 is a bottom or underneath view of the exemplary furrow attachment of FIG. 1;

FIG. 7 is a profile view of the exemplary furrower of FIG. 1;

FIG. 8 is an elevated perspective view of a portable furrower in accordance with the present invention; and

FIG. 9 is an overhead view of an exemplary blade for use with the exemplary furrow attachment of FIG. 1.

### DESCRIPTION OF EXEMPLARY EMBODIMENTS

The exemplary embodiments of the present invention are described and illustrated below to encompass methods of creating furrows using portable power equipment, as well as devices to create furrows, and specifically replacement attachments defining the bounds of the furrows. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

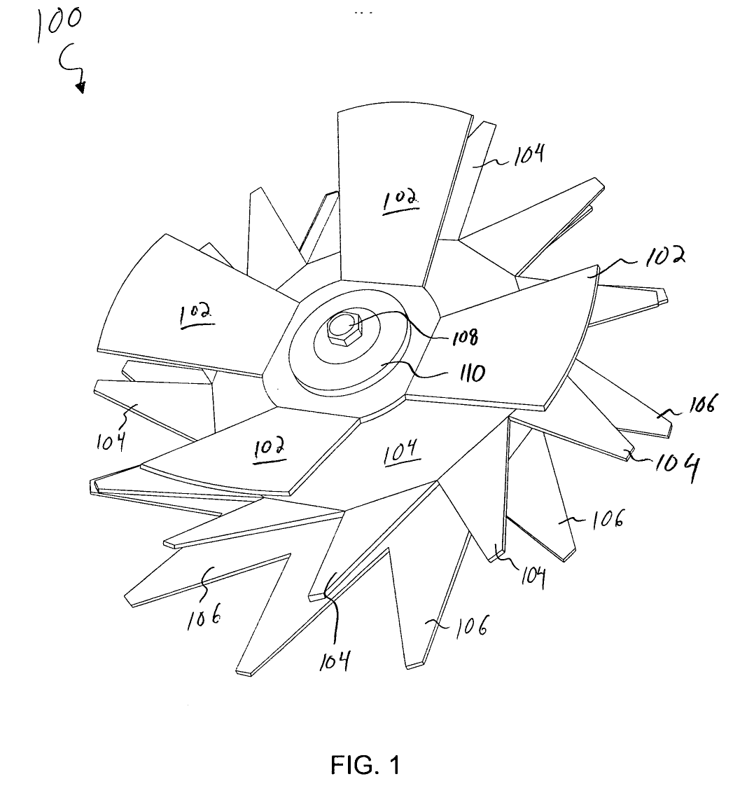

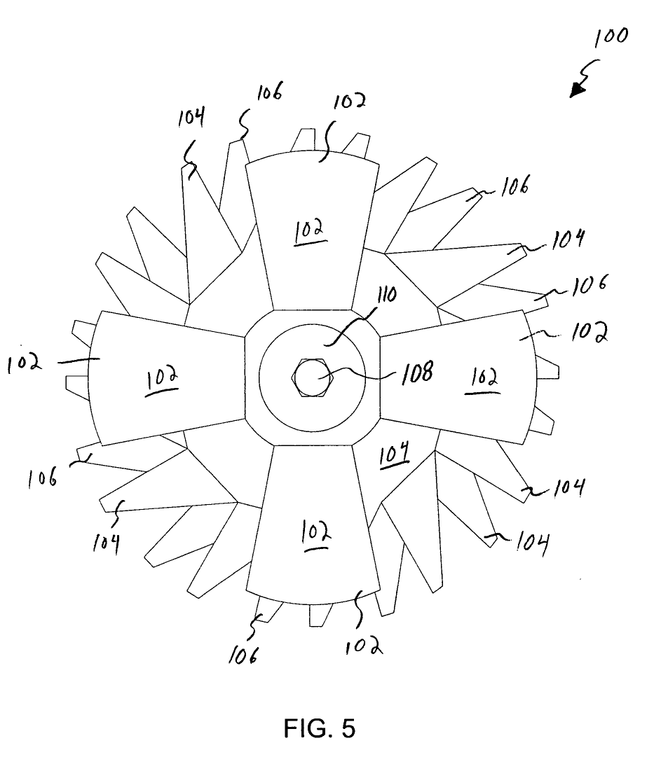

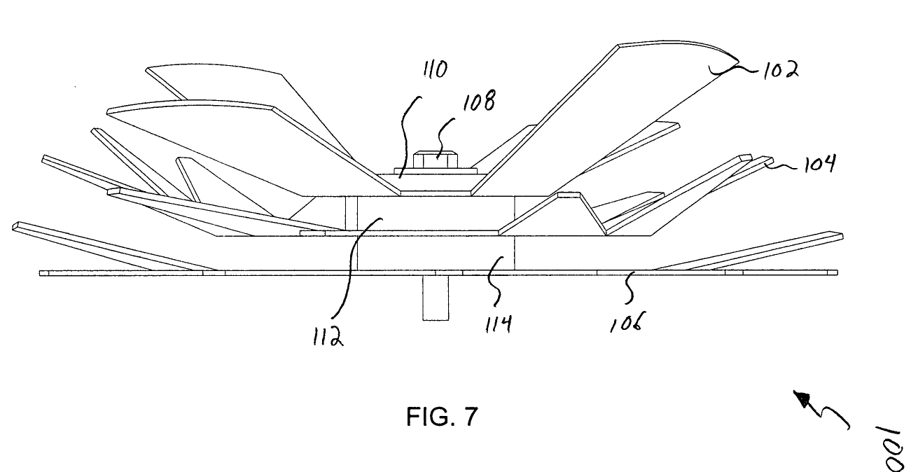

Referencing FIGS. 1-6, a first exemplary furrowing attachment 100 includes a series of cutters 102, 104, 106 spaced apart from one another that operate to dig a furrow (see FIG. 7) within the ground when rotated and positioned adjacent the ground. A fastener 108, such as a bolt, is threaded through a washer 110, the first cutter 102, a first spacer 112, the second cutter 104, a second spacer 114, and finally the third cutter 106 before it is mounted to a receiver of a portable, handheld device (see FIG. 7). An exemplary handheld, portable device is the FC 110 manufactured by Stihl (www.stihl.com). Those skilled in the art will readily be aware of the numerous portable, handheld devices that may be used with the exemplary furrowing attachment 100.

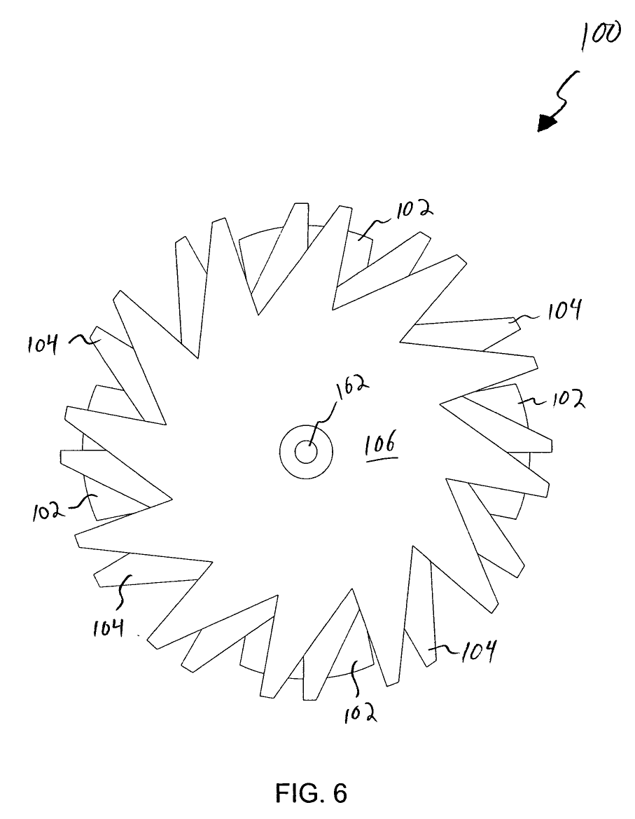

Each successive disc 102, 104, 106 is configured to displace less rotational area than the previous cutter in order to form a furrow (see FIG. 6) having a completely vertical wall with an adjoining beveled wall. Each of the spacers 112, 114 is operative to maintain the separation of the respective cutters, as well as maintain the cutters in the proper orientation, after the fastener 108 is mounted to the power device and during rotational movement of attachment 100. In this exemplary embodiment, each spacer 112, 114 is ½″ in height and includes a hole therethrough large enough to accommodate throughput of the fastener 108. The diameter of the spacer, for purposes of explanation only, is 1⅝″. However, those skilled in the art will readily understand that the particular diameter and height disclosed for each spacer is not critical to practicing the instant invention and may be changed upon end application considerations without departing from the scope of the instant invention.

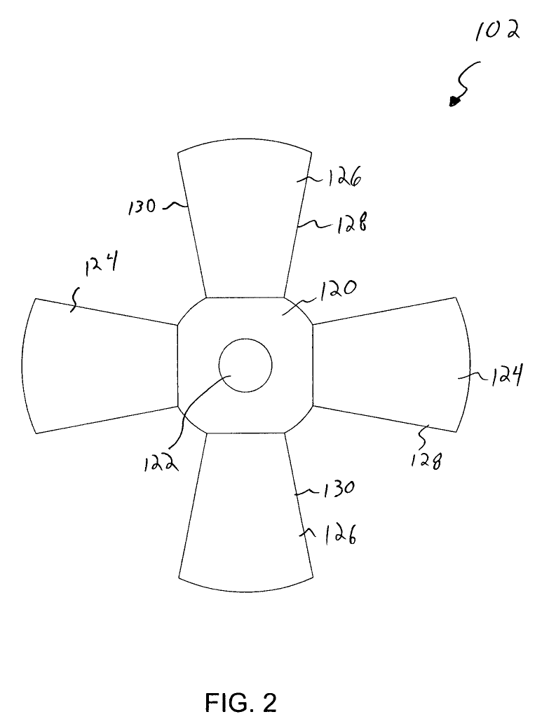

Referring to FIG. 2, in exemplary form, the first cutter 102 is fabricated from 14 gauge steel and includes a hub 120 having a centered hole 122 therethrough to receiver the fastener 108. This first cutter 106 is approximately 8.5″ in diameter and includes four symmetrical, frustroconical blades 124, 126 having a length of approximately 2⅞″, and a cutting length of approximately 2¾″. Each of the blades 126, 126 is bent inward to have an angle of attack (i.e., radial angle) of between six and sixty degrees. For purposes of explanation only, the first two blades 124 are opposite from one another and bent inward to have an angle of attack of approximately 20°, while the other two blades 126 are bent inward to have a radial angle of approximately 35°. In this exemplary embodiment, each blade 124, 126 includes a cutting edge 128 and a backside edge 130, where neither the cutting edge, nor the backside edge is perpendicular with respect to the angle of attack. However, it is also within the scope of the invention to fabricate or orient perpendicularly the cutting edge 128 with respect to the angle of attack, while at the same time positioning the backside edge 130 perpendicular or not with respect to the angle of attack.

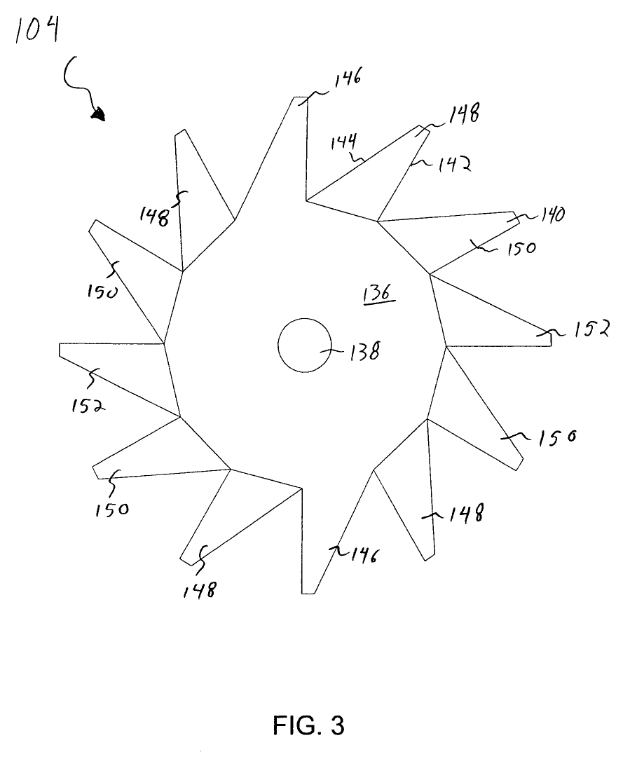

Referring to FIG. 3, the second cutter 104 is also fabricated from 14 gauge steel and includes a hub 136 having a centered hole 138 therethrough to receive the fastener 108. This second cutter 104 is approximately nine 9.5″ in diameter and includes twelve circumferentially and evenly distributed teeth 140, each having a cutting edge 142 length of approximately 2″ and a backside edge 144 length of approximately 2⅝″. A pattern of one co-radial tooth 146 and five angled teeth 148, 150, 152 is repeated two times successively around the circumference of the cutter 104. The five angled teeth 148, 150, 152 in series comprise a least inward bent tooth 148, followed by a more inward bent tooth 150, followed by the most inward bent tooth 152, followed by the more inward bent tooth 150 and finally followed by the least inward bent tooth 148. Each co-radial tooth 146 lies along the same X-Y plane of the hub 136, while the ten angled teeth 148, 150, 152 are incrementally stair stepped upward and downward to each have radial angle of between five and sixty degrees. For purposes of explanation only, the least inward bent teeth 148 include an angle of attack (i.e., radial angle) with respect the hub 136 of approximately 15°, while the more inward bent teeth 150 are angled radially with respect the hub 136 at approximately 25°, while the most inward bent teeth 152 are angled radially with respect the hub 136 at approximately 38°. In this exemplary embodiment, each cutting edge 142 is perpendicular with respect to the angle of attack and the backside edge 144 is not perpendicular with respect to the angle of attack. However, it is also within the scope of the invention to fabricate or orient the cutting edge 144 with respect to the angle of attack other than perpendicular, while at the same time positioning the backside edge 144 perpendicular or not with respect to the angle of attack.

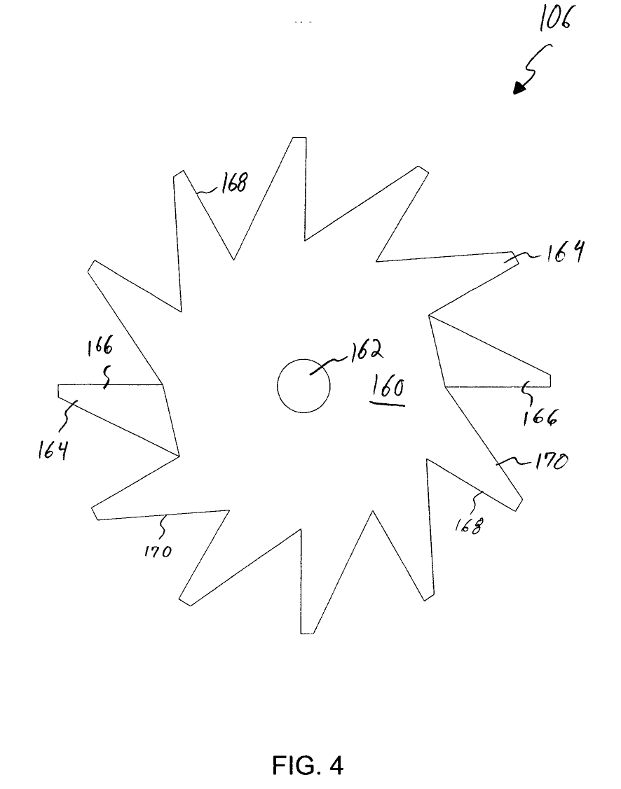

Referring to FIG. 4, the third cutter 106 is also fabricated from 14 gauge steel and includes a hub 160 having a centered hole 162 therethrough to receive the fastener 108. This third cutter 106 is approximately 10″ in diameter and includes twelve circumferentially and evenly distributed teeth 164, each having a cutter length of approximately 2″ and a backside length of approximately 2¾″. Every sixth tooth 166 is bent inward to have an angle of attack (i.e., radial angle) of between five and sixty degrees, while the other teeth remain parallel to the plane of the hub. For purposes of explanation only, the two bent teeth 166 are angled radially with respect the hub at approximately 13°. In this exemplary embodiment, each tooth 164 includes a cutting edge 168 and a backside edge 170, where the cutting edge is perpendicular with respect to the angle of attack and the backside edge is not perpendicular with respect to the angle of attack. However, it is also within the scope of the invention to fabricate or orient the cutting edge 168 with respect to the angle of attack other than perpendicular, while at the same time positioning the backside edge 170 perpendicular or not with respect to the angle of attack.

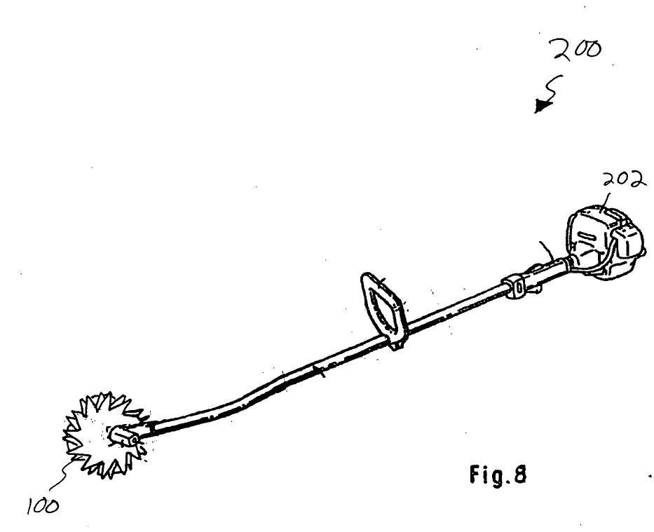

Referring to FIG. 8, an exemplary furrower 200 includes the exemplary furrowing attachment 100 mounted to a portable, handheld device 202. Exemplary handheld, portable devices 202 within the scope of the invention include, without limitation, the FC/FS 55, 75, 90, 95, 100, 110, 250 manufactured by Stihl (www.stihl.com), the HHE31CA manufactured by Honda (www.hondapowerequipment.com), and the 125E and 326EX manufactured by Husqvarna (www.usa.husqvama.com). Those skilled in the art will readily be aware of the numerous portable, handheld devices that may be used with the exemplary furrowing attachment 100 to provide a portable furrower 200 and for purposes of brevity a detailed explanation of the mechanical equipment of a portable device 202 has been omitted.

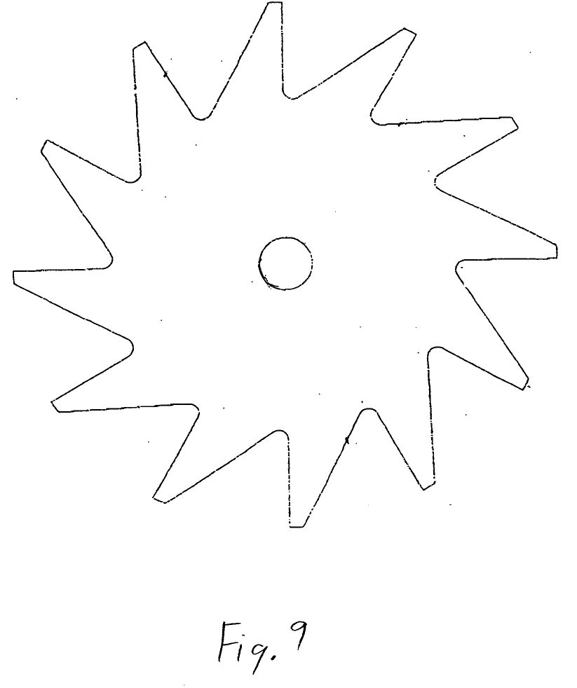

Those skilled in the art will readily understand that the exemplary materials utilizes to fabricate the furrowing attachment 100 may be changed such as, without limitation, changing the 14 gauge metal for another gauge metal or other material. Other changes may be made to the furrowing attachment 100 such as, without limitation, replacing the V-shaped gap between the teeth and hub with a contoured shape such as a U-shaped gap to retard formation of stress cracks (see FIG. 9).

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A furrowing attachment comprising:
at least three cutters axially spaced apart from one another and operatively coupled to one another, the three cutters comprising a second cutting disc interposing a first cutting disc and a cutting blade, the first cutting disc, the second cutting disc, and the cutting blade are coaxial, where each of the cutting discs includes a plurality of circumferentially distributed teeth, at least one of the circumferentially distributed teeth has an angle of attack between five and sixty degrees, and where the second cutting disc has a smaller diameter than the first cutting disc and a greater diameter than the cutting blade, and wherein one rotation of the first cutting disc corresponds with one rotation of the second cutting disc and one rotation of the cutting blade.

2. The furrowing attachment of claim 1, wherein:
the diameter of the first cutting disc is between four to twenty inches;
the diameter of the second cutting disc is between three to nineteen inches; and
the diameter of the cutting blade is between two to eighteen inches.

3. The furrowing attachment of claim 1, wherein:
the first cutting disc includes at least three circumferentially distributed teeth;
the second cutting disc includes at least three circumferentially distributed teeth; and
the cutting blade includes at least two blades.

4. The furrowing attachment of claim 1, wherein:
the at least one inwardly angled tooth of the first cutting disc includes a cutting edge normal the angle of attack; and
the at least one inwardly angled tooth of the second cutting disc includes a cutting edge normal to the angle of attack.

5. The furrowing attachment of claim 1, further comprising:
a plurality of spacers interposing the at least three cutters, where each of the spacers includes a orifice therethrough; and
a threaded fastener;
wherein each of the at least three cutters includes an opening through a center thereof; and
wherein the threaded fastener passes through each orifice of the spacers and each opening of the at least three cutters to maintain the orientation of the spacers and the at least three cutters with respect to one another.

6. The furrowing attachment of claim 1, wherein at least one of the circumferentially distributed teeth of at least one of the first disc, the second disc, and the third disc is radially aligned and in parallel with a hub of its corresponding disc.

7. The furrowing attachment of claim 6, wherein:
at least one of the circumferentially distributed teeth of each of the first disc, the second disc, and the third disc is radially aligned and in parallel with the hub of its corresponding disc.

8. The furrowing attachment of claim 1, wherein:
the second cutting disc includes at least three circumferentially distributed teeth;
the three circumferentially distributed teeth are each angled between five and sixty degrees; and
the angles of each of the three circumferentially distributed teeth differ from one another.

9. The furrowing attachment of claim 8, wherein:
the three circumferentially distributed teeth are in series with one another; and
the angles of each of the three circumferentially distributed teeth incrementally increase with respect to one another.

10. A furrowing attachment comprising:
a first wheel including a rotational axis and at least two cutting projections radially spaced from the rotational axis and angled with respect to the rotational axis between twenty and eighty-five degrees, the first wheel also including at least one cutting edge substantially perpendicular to the rotational axis; and
a second wheel operatively coupled to the first wheel and axially spaced apart from the first wheel, the second wheel including a rotational axis coaxial with the rotational axis of the first wheel, the second wheel including at least two cutting projections radially spaced from the rotational axis and angled with respect to the rotational axis between twenty and eighty-five degrees, the second wheel also including at least one cutting edge substantially perpendicular to the rotational axis;
wherein a radius of the first wheel is less than a radius of the second wheel; and
wherein one rotation of the first wheel corresponds with one rotation of the second wheel.

11. The furrowing attachment of claim 10, wherein:
the second wheel includes at least five cutting projections radially spaced from the rotational axis and angled with respect to the rotational axis between twenty and eighty-five degrees;
the at least five cutting projections are arranged in an undulating pattern.

12. The furrowing attachment of claim 10, wherein:
the first wheel includes at least four cutting edges substantially perpendicular to the rotational axis; and
the first wheel includes only two cutting projections radially spaced from the rotational axis and angled with respect to the rotational axis between twenty and eighty-five degrees;

13. The furrowing attachment of claim 10, further comprising at least two blades axially spaced apart from the first wheel and the second wheel, where the at least two blades are further axially spaced apart from the first wheel than the second wheel, and where each blade includes a radial dimension less than a radius of the second wheel.

14. The furrowing attachment of claim 10, further comprising a series of angled blades axially spaced apart from the first wheel and the second wheel, where at least one of the series of blades includes a radial dimension less than a radius of the second wheel.

15. The furrowing attachment of claim 10, further comprising
a third wheel operatively coupled to the second wheel and axially spaced apart from the second wheel, the third wheel including a rotational axis coaxial with the rotational axis of the second wheel, the third wheel including at least two cutting projections radially spaced from the rotational axis and angled with respect to the rotational axis between twenty and eighty-five degrees.

16. The furrowing attachment of claim 10, wherein:
at least one of the at least two cutting projections includes a frustroconical shape.

17. A handheld furrower comprising:
a handheld, portable piece of equipment having an internal combustion engine coupled to a drive shaft that is coupled to a rotational end, the internal combustion engine having a throttle control operative to at least one of increase and decrease rotation of the rotational end; and
a furrowing attachment coupled to the rotational end of the handheld, portable piece of equipment, the furrowing attachment comprising at least three cutters axially spaced apart from one another and operatively coupled to one another, the three cutters comprising a second cutting disc interposing a first cutting disc and a cutting blade, the first cutting disc, the second cutting disc, and the cutting blade are coaxial, where each of the cutting discs includes a plurality of circumferentially distributed teeth, at least one of the circumferentially distributed teeth has an angle of attack between five and sixty degrees, and where the second cutting disc has a smaller diameter than the first cutting disc and a greater diameter than the cutting blade, and wherein one rotation of the first cutting disc corresponds with one rotation of the second cutting disc and one rotation of the cutting blade.
